(19) United States
(12) Patent Application Publication
(10) Pub. No.: US 2012/0003420 A1
(43) Pub. Date: Jan. 5, 2012

(54) HONEYCOMB STRUCTURE BODY AND METHOD OF PRODUCING THE SAME

(75) Inventors: Takahiro Betsushiyo, Handa-shi (JP); Hiromasa Aoki, Nagoya (JP); Kazuhisa Sakamoto, Tokyo (JP)

(73) Assignees: TOKAI KONETSU KOGYO CO., LTD., Tokyo (JP); DENSO CORPORATION, Kariya-city (JP)

(21) Appl. No.: 13/175,080

(22) Filed: Jul. 1, 2011

(30) Foreign Application Priority Data
Jul. 2, 2010 (JP) 2010-151834
May 12, 2011 (JP) 2011-106916

(51) Int. Cl. B32B 3/12; B05D 3/02

(52) U.S. Cl. 428/116; 427/397.7

(57) ABSTRACT

A honeycomb structure body has a honeycomb base body and a pair of electrodes composed of conductive ceramic layers and intermediate layers. The honeycomb base body made of porous ceramics containing SiC is comprised of a cell formation part and an outer peripheral part. The outer peripheral part covers the cell formation part. Each electrode is comprised of a conductive ceramic layer and an intermediate layer. The conductive ceramic layers containing SiC, Si and C are formed at two opposite positions on the outer peripheral part observed from a diameter direction. The intermediate layers containing SiC, Si and C are formed in the outer peripheral part at the parts which face the conductive ceramic layers. The honeycomb structure body satisfies a relationship of 0.5≦t/T≦1, where “t” indicates the thickness of the intermediate layer and “T” indicates the thickness of the outer peripheral part.

### CROSS-REFERENCE TO RELATED APPLICATION

This application is related to and claims priority from Japanese Patent Applications No. 2010-151834 filed on Jul. 2, 2010 and No. 2011-106916 filed on May 12, 2011, the contents of which are hereby incorporated by reference.

### BACKGROUND OF THE INVENTION

1. Field of the Invention

The present invention relates to honeycomb structure bodies and methods of producing honeycomb structure bodies. In particular, the honeycomb structure body is made of porous ceramic and has a pair of electrodes formed on the surface of the honeycomb structure body.

2. Description of the Related Art

In general, a catalyst converter is used in an exhaust gas pipe of a motor vehicle. For example, a honeycomb structure body is used as the catalyst converter, and the honeycomb structure body supports noble metal catalyst such as platinum (Pt), palladium (Pd), and rhodium (Rh) therein.

By the way, it is necessary to heat the honeycomb structure body approximately at a temperature of 400° C. in order to activate the catalyst supported in the honeycomb structure body. In order to supply electric power and heat the honeycomb structure body, a pair of electrodes is formed on the surface of the honeycomb structure body. An electric power source supplies electric power to the paired electrodes in order to heat the honeycomb structure body and activate the catalyst supported therein. Such a technique is called to as the “electric heating catalyst (EHC) converter”.

There are various types of honeycomb structure bodies, which can be applied to the EHC converter. One type of them has a structure in which a pair of electrodes is made of a metal layer. Another type of them has a structure in which a pair of electrodes is made of a composite material of silicon. For example, Japanese patent laid open publication No. JP 2003-327478 discloses a heating body made of silicon carbide (SiC). A connection part of the heating body made of silicon carbide is composed of a heating part made of silicon carbide and an end part made of composite material.

Japanese patent laid open publication No. JP 2008-05927 discloses a method of connecting a SiC porous body to a SiC—Si composite. In order to permeate silicon (Si) contained in the SiC—Si composite into an adhesion layer, this method executes a heat treatment when the SiC porous body and the SiC—Si composite are adhered together by the adhesion layer. In the method, silicon (Si) is impregnated. This method makes it possible to produce a dense adhesion layer and increase the mechanical strength of the connection between the porous SiC body and the SiC—Si composite.

However, the conventional method of producing the EHC converter, previously described, requires a special technique to uniformly and rapidly increase the temperature of the honeycomb structure body until the temperature of the honeycomb structure body reaches a predetermined temperature at which the catalyst is adequately activated. In order to satisfy the conditions, it is necessary for the paired electrodes to have predetermined heat resistance property, predetermined acid resistance property, predetermined electrical connection reliability, and predetermined mechanical connection reliability. The predetermined electrical connection reliability indicates the degree of changing a resistance value of the honeycomb structure body in use, and the predetermined mechanical connection reliability indicates the degree of separating the electrodes from the honeycomb structure body and causing damage.

The conventional techniques such as the techniques disclosed in Japanese patent laid open publication No. JP 2003-327478 and Japanese patent laid open publication No. JP 2008-105927, previously described, do not adequately satisfy the above strict conditions.

### SUMMARY

It is an object of the present invention to provide a honeycomb structure body and a method of producing the honeycomb structure body capable of adequately satisfying predetermined electrical connection reliability and mechanical connection reliability even if the honeycomb structure body is repeatedly used, namely, heated by receiving electric power.

To achieve the above purposes, the present exemplary embodiment provides a honeycomb structure body. The honeycomb structure body has a honeycomb base body and at least a pair of conductive ceramic layers and intermediate layers. The honeycomb base body is composed of porous ceramics made of silicon carbide (SiC) having a porosity within a range of 30% to 50%. The honeycomb base body is comprised of a cell formation part and an outer peripheral part. The outer periphery of the cell formation part is covered with the outer peripheral part. The paired conductive ceramic layers are made of silicon carbide (SiC) and silicon (Si) formed on the outer peripheral part. The paired intermediate layers are made of silicon carbide (SiC) and silicon (Si) formed in the outer peripheral part at the position, and correspond to the conductive ceramic layers. In particular, the honeycomb structure body satisfies a relationship of 0.5≦t/T≦1, where “t” indicates the thickness of the intermediate layer and “T” indicates the thickness of the outer peripheral part.

In the honeycomb structure body as one exemplary embodiment, the pair of the conductive ceramic layers made of composite material containing silicon carbide (SiC) and silicon (Si) is formed on the surface of the outer peripheral part of the honeycomb base body. The intermediate layer containing silicon carbide (SiC) and silicon (Si) is formed in the outer peripheral part of the honeycomb base body, which faces the corresponding conductive ceramic layer.

In particular, the honeycomb structure body satisfies the relationship of 0.5≦t/T≦1, where “t” indicates the thickness of the intermediate layer and “T” indicates the thickness of the outer peripheral part.

Because the thickness “t” of the intermediate layer is not less than the half of the thickness “T” of the outer peripheral part, it is possible to suppress changing the resistance value of the paired electrodes when the paired electrodes repeatedly used, namely, receive electric power. This makes it possible to prevent the paired electrodes from being separated and damaged.

Further, because the thickness “t” of the intermediate layer is not more than the thickness “T” of the outer peripheral part, it is possible to prevent the intermediate layer from being formed in the cell formation part. This makes it possible to decrease the electrical resistance of the cell formation part and to prevent the temperature rising capability of the honeycomb structure body from being deteriorated.

Still further, when the honeycomb base body has the porosity of less than 30%, the total mass of the honeycomb base body is increased. This needs a large amount of electric power and period of time to supply electric power to the honeycomb structure body in order to heat the honeycomb structure body.

On the other hand, when the honeycomb base body has the porosity of more than 50%, the strength of the honeycomb base body is decreased, and the honeycomb structure body is easily damaged.

The honeycomb structure body according to an exemplary embodiment has the superior electric connection reliability and the superior mechanical connection reliability when repeatedly receiving the electric power in order to activate the catalyst supported by the cell walls in the honeycomb structure body.

In accordance with another exemplary embodiment, there is provided a method of producing a honeycomb structure body. The honeycomb base body is comprised of a honeycomb base body and at least a pair of conductive ceramic layers and intermediate layers. The method has a first step and a second step. The first step places or applies composite material or paste containing silicon carbide (SiC) and carbon (C) on an outer peripheral part of the honeycomb base body through adhesion paste containing silicon carbide (SiC) and carbon (C). The second step heats and fires the adhesive and the composite material or paste. In particular, the first step adjusts a ratio “Si/C” between silicon (Si) contained in the composite material or paste and carbon (C) contained in the adhesive in order for the second step to permeate silicon (Si) contained in the composite material or paste and carbon (C) contained in the adhesive into the inside of the outer peripheral part and to satisfy a relationship of 0.5≦t/T≦1, where “t” indicates the thickness of the intermediate layer and “T” indicates the thickness of the outer peripheral part.

The first step in the method of producing the honeycomb structure body adjusts the ratio “Si/C” in mass % between silicon (Si) contained in the composite material or paste and carbon (C) in the adhesive and applies the composite material or paste on the surface of the outer peripheral part through the adhesive. The second step heats and fires the composite material or paste and the adhesive applied on the outer peripheral part in the honeycomb structure body. This permeates silicon (Si) contained in the composite material or paste and carbon (C) contained in the adhesive into the inside of the outer peripheral part in order to satisfy the relationship of 0.5≦t/T≦1, where “t” indicates the thickness of the intermediate layer and “T” indicates the thickness of the outer peripheral part. Each electrode composed of the conductive ceramic layer and the intermediate layer is thereby formed on the honeycomb base body in the honeycomb structure body.

Accordingly, the method as another exemplary embodiment produces the honeycomb structure body having the superior electric connection reliability and the superior mechanical connection reliability even if repeatedly receiving electric power in order to activate the catalyst supported by the cell walls in the honeycomb structure body.

### BRIEF DESCRIPTION OF THE DRAWINGS

A preferred, non-limiting embodiment of the present invention will be described by way of example with reference to the accompanying drawings, in which:

FIG. 1 is a view showing a cross section of an electrode formation part in a honeycomb structure body according to an exemplary embodiment of the present invention;

FIG. 2 is a perspective view showing the honeycomb structure body according to the exemplary embodiment having a pair of electrodes formed at opposite parts on the outer periphery of the honeycomb structure body observed along a diameter direction thereof;

FIG. 3 is a perspective view showing the honeycomb structure body according to the exemplary embodiment having a pair of electrodes formed at different parts on the outer periphery of the honeycomb structure body observed along an axial direction thereof;

FIG. 4 is a view showing a cross section of a SiC—Si composite formed on the surface of the honeycomb structure body by adhesive;

FIG. 5 is a view showing a cross section of the honeycomb structure body according to the exemplary embodiment in which an electrode composed of a conductive ceramic layer and an intermediate layer is formed;

FIG. 6 is a view showing an enlarged cross section of the honeycomb structure body according to the exemplary embodiment in which the SiC—Si composite is formed on the outer periphery of the honeycomb structure body by using adhesive;

FIG. 7 is a view showing an enlarged cross section of the honeycomb structure body according to the exemplary embodiment in which the conductive ceramic layer and the intermediate layer are formed;

FIG. 8A is a view showing a cross section of the conductive ceramic layer in the honeycomb structure body according to the exemplary embodiment magnified 200 times by using an electron microscope;

FIG. 8B is a view showing a cross section of a connection part between the conductive ceramic layer and the intermediate layer in the outer peripheral part of the honeycomb structure body according to the exemplary embodiment magnified 50 times by using an electron microscope;

FIG. 8C is a view showing an enlarged cross section of a part E (which is surrounded by dotted line) which indicates the connection part shown in FIG. 8B;

FIG. 9 is a view showing an electric circuit model when a voltage is applied to and current flows in the honeycomb structure body according to the exemplary embodiment; and

FIG. 10 is a view showing a flow chart of producing the honeycomb structure body according to the exemplary embodiment.

### DETAILED DESCRIPTION OF THE PREFERRED EMBODIMENTS

Hereinafter, various exemplary embodiments of the present invention will be described with reference to the accompanying drawings. In the following description of the various exemplary embodiments, like reference characters or numerals designate like or equivalent component parts throughout the several diagrams.

A description will be given of an exemplary embodiment of the honeycomb structure body and a method of producing the honeycomb structure body according to the present invention.

In the honeycomb structure body according to an exemplary embodiment, a thickness of an intermediate layer can be detected by observing a cross section obtained by cutting a formation part of the honeycomb structure body in which a conductive ceramic layer and the intermediate layer are formed. Specifically, ten detection points on the part of the honeycomb structure body in which the conductive ceramic layer and the intermediate layer are formed are detected by using a scanning electron microscope (SEM) or a digital microscope. An average value of the detected thicknesses of the intermediate layer is used as the thickness of the intermediate layer.

It is preferred for the conductive ceramic layer in the honeycomb structure body to have not more than 0.1 mass % of aluminum contained therein. In order to have an effective conductivity of silicon carbide (SiC) and silicon (Si), it is widely used to adding impurities in order to obtain a semiconductor material layer. When the conductive ceramic layer is aluminum rich, aluminum is dispersed in the intermediate layer when a heat treatment process is executed at a temperature within a range of 1410° C. to 1800° C. in order to produce the intermediate layer. This case is not preferred because the resistance value of the honeycomb structure body is fluctuated. In general, the honeycomb structure body has a predetermined adjusted resistance value.

Accordingly, the content of aluminum in the conductive ceramic layer which is necessary to have a semiconductor property, namely, is not more than 0.1 mass %. In this case, the content of aluminum in the conductive ceramic layer is within a range of 0.01 mass % to 0.1 mass %.

It is preferred for silicon carbide (SiC) in the conductive ceramic layer and the intermediate layer to have not less than 30% of at least one of crystal system of 4H type and 3C type.

Silicon carbide (SiC) has a plurality of crystal structures having different electron mobility. The crystal systems of 4H type and 3C type are generated at a low temperature and have high electron mobility and have better conductive properties than those of 6H type which is generated at a high temperature.

Silicon carbide (SiC) of a low temperature type is generated at a temperature within a range of 1410° C. to 2200° C. It is therefore preferred to produce the conductive ceramic layer and the intermediate layer in the honeycomb structure body at a temperature within a range of 1410° C. to 1800° C. by thermal treatment (conjunction processing temperature). This process makes it possible to reliably form silicon carbide (SiC) in the intermediate layer in the outer periphery of the honeycomb structure body at a low temperature.

It is preferred for the conductive ceramic layer and the intermediate layer to contain carbon (C) in addition to silicon carbide (SiC) and carbon (C). This structure makes it possible to decrease the resistance value of the electrodes and increase the conductivity of the electrode which are formed in the conductive ceramic layer and the intermediate layer.

It is preferred for the conductive ceramic layer and the intermediate layer in the honeycomb structure body to contain silicon carbide (SiC) within a range of 70 mass % to 94 mass %, carbon (C) within a range of 5 to 20 mass %, and carbon (C) within a range of 1 mass % to 10 mass %.

In the structure of the honeycomb structure body, the silicon carbide (SiC) acts as strong aggregate in the conductive ceramic layer and the intermediate layer. The silicon (Si) is melted and dispersed in the conductive ceramic layer and the intermediate layer. This silicon (Si) acts as adhesive. The carbon (C) acts as a conductive material. Accordingly, it is possible to produce the honeycomb structure body having a superior reliability of electric and mechanical conjunction. It is possible to detect a composition of the conductive ceramic layer by using chemical analysis method indicated by JIS (Japanese Industrial Standard) R 6124.

It is preferred for the conductive ceramic layer to have a thickness within a range of 0.5 mm to 2 mm.

This structure makes it possible to easily make the intermediate layer having an optimum thickness in the production of the honeycomb structure body because the conductive ceramic layer has an optimum thickness.

When the thickness of the conductive ceramic layer is less than 0.5 mm, it is difficult to form the electrodes on the outer peripheral part of the honeycomb structure body because of having a rough shape.

On the other hand, when the thickness of the conductive ceramic layer exceeds 2 mm, it is necessary to form the honeycomb structure body to receive a large amount of electric power in order to heat the honeycomb structure body to the necessary temperature because the electrodes have a large mass. This structure needs a long period of time of supplying electric power in order to activate the catalyst supported in the honeycomb structure body when compared with the electrodes having a usual mass to which the same electric power is supplied. In addition, this structure would cause damage to the honeycomb structure body having a cylindrical shape when the honeycomb structure body is mounted to an exhaust gas pipe of the internal combustion engine of a motor vehicle. There is a possibility for the honeycomb structure body would be broken when the motor vehicle drives or when the honeycomb structure body is fitted into the exhaust gas pipe of an exhaust gas purifying system.

It is preferred for the thickness of the outer periphery of the honeycomb structure body to be within a range of 0.1 mm to 1 mm.

This structure makes it possible to easily form the intermediate layer having an optimum thickness in connection with the thickness of the outer periphery because the outer periphery of the honeycomb structure body has an optimum thickness.

It is difficult to form the outer periphery having less than 1 mm thickness. On the other hand, when the outer peripheral part of the honeycomb structure body has a thickness of more than 1 mm, there is a possibility of it being difficult to produce the intermediate layer having a desired thickness because the thickness of the intermediate layer has a large variation (or dispersion).

It is preferred to form a pair of electrodes by connecting the conductive ceramic layer and the intermediate layer together, and an electric resistance of each of the electrodes is not more than 10% of the electric resistance between the pair of the electrodes.

This structure makes it possible to maintain the electric resistance of the electrodes formed by the conductive ceramic layer and the intermediate layer as low as possible. This structure saves heat energy generated when a predetermined electric power is supplied to the pair of the electrodes, and thereby suppresses a power consumption of the pair of the electrodes.

### Embodiment

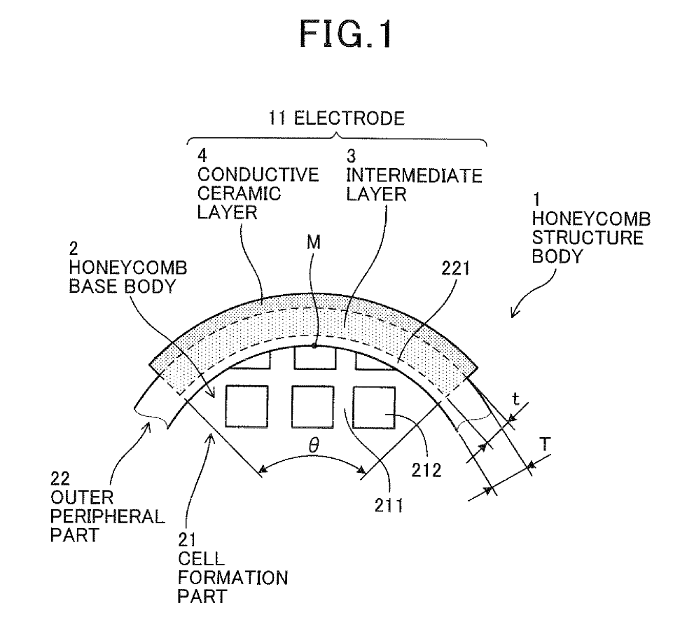

A description will now be given of the honeycomb structure body according to an exemplary embodiment of the present invention with reference to FIG. 1 to FIG. 9.

FIG. 1 is a view showing a cross section of an electrode formation part in the honeycomb structure body according to the exemplary embodiment of the present invention.

As shown in FIG. 1, the conductive ceramic layer 4 and the intermediate layer 3 are formed on the honeycomb base body 2. The conductive ceramic layer 4 and the intermediate layer 3 act as a pair of the electrodes 11.

The honeycomb base body 2 is comprised of a cell formation part 21 and an outer peripheral part 22. The cell formation part 21 and the outer peripheral part 22 are made of porous ceramics having a porosity within a range of 30% to 50%. The porous ceramics is made of silicon carbide (SiC) (sometimes, containing unavoidable impurity material). The outer peripheral part 22 surrounds the surface of the cell formation part 21.

The conductive ceramic layer 4 has a pair of parts which is formed on the surface of the outer peripheral part 22.

The intermediate layer 3 contains silicon carbide (SiC), silicon (Si) and carbon (C). The intermediate layer 3 is formed in the outer peripheral part 22 so that the intermediate layer 3 faces the conductive ceramic layer 4.

In particular, the honeycomb structure body 1 according to the exemplary embodiment is formed to satisfy the following relationship:

0.5≦t/T≦1, where “t” indicates the thickness of the intermediate layer 3 and “T” indicates the thickness of the outer peripheral part 22.

A description will now be given of the method of producing the honeycomb structure body 1 according to the exemplary embodiment of the present invention with reference to FIG. 1 to FIG. 9.

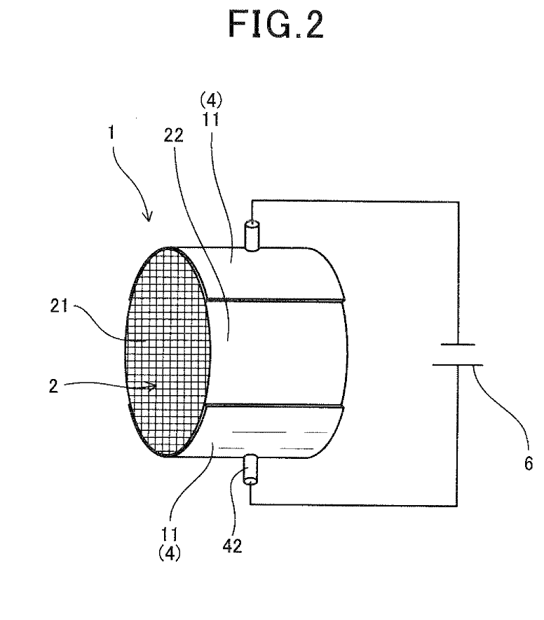

FIG. 2 is a perspective view showing the honeycomb structure body 1 according to the exemplary embodiment having the paired electrodes 11 formed at opposite parts on the outer peripheral part 22 of the honeycomb structure body 1 observed in a diameter direction of the honeycomb structure body 1.

As shown in FIG. 1 and FIG. 2, the honeycomb base body 2 has a cylindrical shape and is comprised of partition walls 211 and cell parts. The partition walls 211 are formed in the cell formation part 21 (as a lattice shaped part). The partition walls 211 form the cell parts 212. The outer periphery of the honeycomb base body 2 is covered with the outer peripheral part 22.

As shown in FIG. 2, an electric power source 6 (see FIG. 2) supplies electric power to the paired electrodes 11 composed of the conductive ceramic layer 4 and the intermediate layer 3 in the honeycomb structure body 1 according to the exemplary embodiment. This supplies heat energy to the honeycomb base body 2 of the honeycomb structure body 1 in order to adequately activate catalyst supported in the partition walls 211. That is, the honeycomb structure body 1 according to the exemplary embodiment acts as an electric heating catalyst (EHC) converter capable of purifying exhaust gas emitted from an internal combustion engine.

A pair of terminal parts 42 is formed in the pair of the conductive ceramic layers 4. Each of the terminal parts 42 is made of SiC—Si composite material. The electric power source 6 is electrically connected to the paired terminal parts 42 in order to supply electric power to the honeycomb structure body 1 through the paired electrodes 11.

As shown in FIG. 2, each of the paired electrodes 11 is composed of the conductive ceramic layer 4 and the intermediate layer 3 and is formed at the opposite positions observed in an axial direction of the honeycomb structure body 1 on the surface of the outer peripheral part 22 of the honeycomb base body 2 having a cylindrical shape. The paired electrodes 11 are formed at the different positions on the outer peripheral part 22 and face to each other along a diameter direction of the honeycomb structure body 1 which is perpendicular to an axial direction of the honeycomb structure body 1.

It is also possible to form one or more pairs of the conductive ceramic layers 4 at different parts on the honeycomb base body 2 as long as electric power is supplied to the electrodes 11 through the conductive ceramic layers 4. That is, it is possible to form one or more pairs of conductive ceramic layers 4 having following different structures in which:

(a) the paired conductive ceramic layers 4 face to each other;

(b) the paired conductive ceramic layers 4 face in a part thereof to each other; and

(c) the paired conductive ceramic layers 4 do not face to each other.

It is possible for the conductive ceramic layers 4 and the intermediate layers 3 to have any structure as long as the electric power can be supplied to the paired electrodes 11 through the conductive ceramic layers 4.

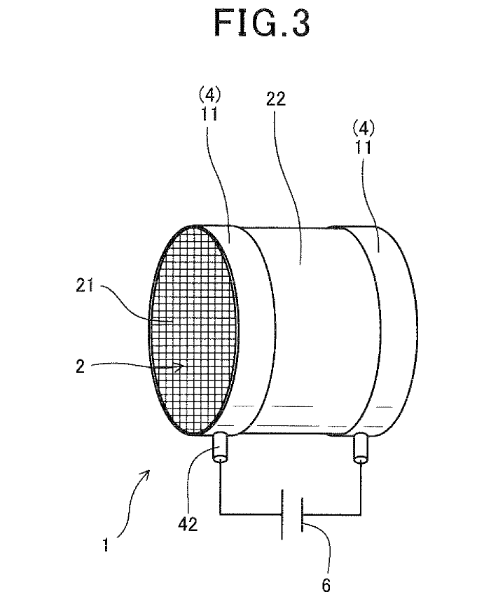

FIG. 3 is a perspective view showing the honeycomb structure body 1 according to the exemplary embodiment having the paired electrodes 11 formed at different positions on the outer periphery of the honeycomb structure body along an axis direction. As shown in FIG. 3, it is possible for the honeycomb structure body 1 to have the paired electrodes 11 which are formed in series along an axial direction, namely, the longitudinal direction of the honeycomb structure body 1.

It is preferred that the paired electrodes 11, which are composed of the conductive ceramic layer 4 and the intermediate layer 3, are faced to each other.

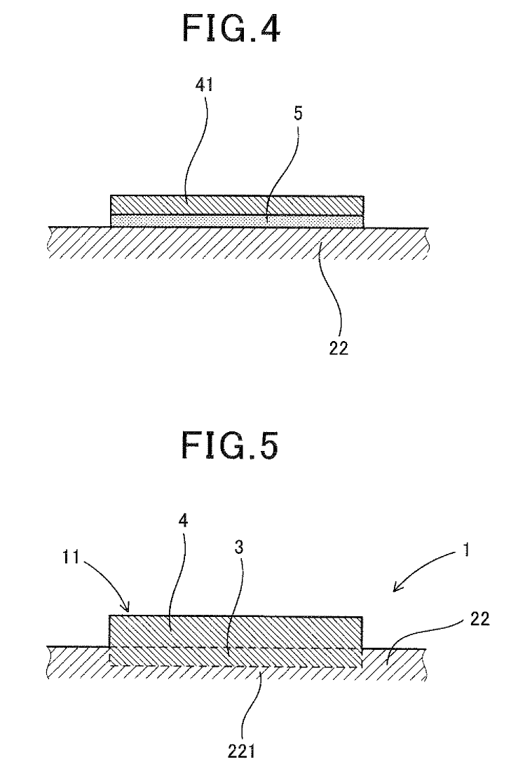

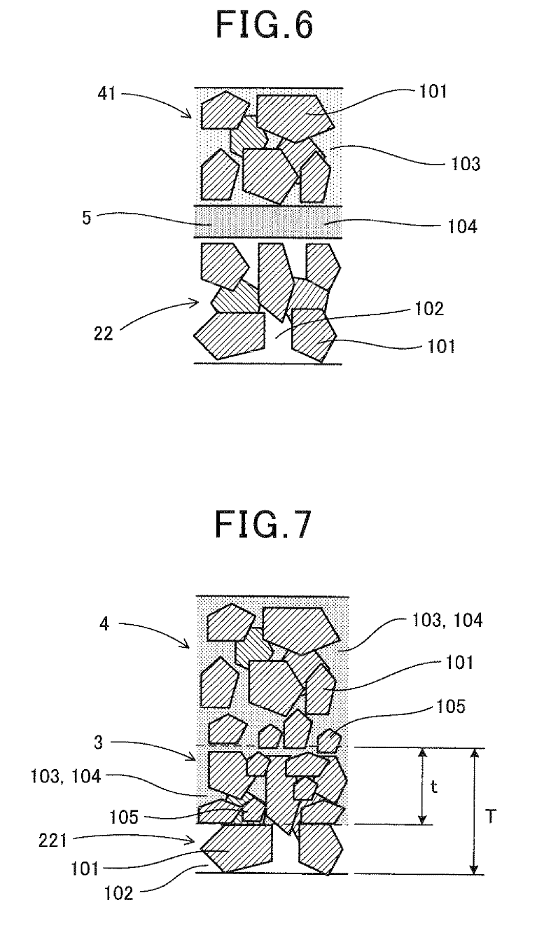

FIG. 4 is a view showing a cross section of a SiC—Si composite formed on the surface of the honeycomb structure body 1 by the adhesive 5. FIG. 5 is a view showing a cross section of the honeycomb structure body 1 according to the exemplary embodiment in which the electrode 11 composed of the conductive ceramic layer 4 and the intermediate layer 3 is formed. FIG. 6 is a view showing an enlarged cross section of the honeycomb structure body 1 according to the exemplary embodiment in which the SiC—Si composite is formed on the outer peripheral part 22 of the honeycomb structure body 1 by using adhesive. FIG. 7 is a view showing an enlarged cross section of the honeycomb structure body 1 according to the exemplary embodiment in which the conductive ceramic layer 4 and the intermediate layer 3 are formed.

As shown in FIG. 4 to FIG. 7, the intermediate layer 3 is made of porous ceramics 102 having pores, silicon (Si), carbon (C), etc. in which the pores (porous parts such as tiny holes or small openings) in the porous ceramics 102 are filled with silicon (Si), carbon (C), etc. The outer peripheral part 22 of the honeycomb structure body 1 is composed of such porous ceramics.

As shown in FIG. 4 and FIG. 5, the intermediate layer 3 is formed in the part of the outer peripheral part 22 in which silicon carbide (SiC) is formed. The silicon (Si) and carbon (C) are permeated into the part in the outer peripheral part 22 through the adhesive 5. The conductive ceramic layer 4 is adhered onto the outer peripheral part 22 by the adhesive 5.

The conductive ceramic layer 4 and the intermediate layer 3 are formed in the honeycomb structure body 1 according to the exemplary embodiment so that the conductive ceramic layer 4 and the intermediate layer 3 contain silicon carbide (SiC), silicon (Si) and carbon (C). In particular, the adhesive 5 contains carbon (C). Carbon (C) is permeated into the conductive ceramic layer 4 and the intermediate layer 3. The adhesive 5 connects the SiC—Si composite 41 and the outer peripheral part 22 together. The conductive ceramic layer 4 is made of the SiC—Si composite 41. In addition, it is preferred for the porosity “p” of the intermediate layer 3 in the outer peripheral part 22 to have the following relationship:

p≦½ P, where “P” is a porosity of a base layer 221 of the honeycomb base body 2. No silicon (Si) and carbon (C) are permeated into the base layer 221.

FIG. 4 to FIG. 7 are the views schematically showing a cross section of components which form the conductive ceramic layer 4, the intermediate layer 3 and the outer peripheral part 22.

In particular, FIG. 4 and FIG. 6 show the case in which the SiC—Si composite 41 is arranged on the surface of the outer peripheral part 22 in the honeycomb base body 2. The conductive ceramic layer 4 is formed on the surface of the outer peripheral part 22 by the adhesive 5.

As shown in FIG. 6, a plurality of pores 102 is formed in the outer peripheral part 22. A plurality of silicon carbide (SiC) particles is fitted into the pores 102. On the other hand, the SiC—Si composite 41 contains free silicon (Si) particles 103 between a plurality of silicon carbide (SiC) particles. As previously described, the adhesive 5 contains free carbon (C).

FIG. 5 and FIG. 7 show the case in which the conductive ceramic layer 4 is formed on the surface of the outer peripheral part 22 of the honeycomb base body 2 and the intermediate layer 3 is formed in the outer peripheral part 22 so that the intermediate layer 3 is exposed on the surface of the outer peripheral part 22 of the honeycomb base body 2. The conductive ceramic layer 4 and the intermediate layer 3 are formed by the following steps:

(s1) the SiC—Si composite 41 is placed on the surface of the outer peripheral part 22 of the honeycomb base body 2 by the adhesive 5; and

(s2) the SiC—Si composite 41 placed on the surface of the outer peripheral part 22 is heated and fired at a predetermined temperature in order to form the conductive ceramic layer 4 on the surface of the outer peripheral part 22 of the honeycomb base body 2 and the intermediate layer 3 in the surface side of the outer peripheral part 22.

In particular, as shown in FIG. 7, the intermediate layer 3 is formed in the outer peripheral part 22 so that the intermediate layer 3 is exposed from the outer peripheral part 22. Free silicon (Si) particles 103 contained in the SiC—Si composite 41 and carbon (C) particles 104 contained in the adhesive 5 are melted, dispersed and permeated into the gaps. The gaps are formed between the silicon carbide (SiC) particles 101 in the surface side of the outer peripheral part 22 of the honeycomb base body 2.

In addition, chemical reaction occurs between a part of the permeated free silicon (Si) particles 103 and a part of the permeated free carbon (C) particle 104 in the gaps (a plurality of pores) 102 between the silicon carbide (SiC) particles 101 in the intermediate layer 3. This chemical reaction produces new silicon carbide (SiC) 105 as products of silicon carbide.

On the other hand, chemical reaction occurs between a part of the free silicon (Si) particles 103 originally contained in the SiC—Si composite 41 and a part of the free carbon (C) particles 104 permeated from the adhesive 5 in the surface of the conductive ceramic layer 4 at the surface side of the intermediate layer 3. This chemical reaction produces new silicon carbide (SiC) 105 as products. The conductive ceramic layer 4 and the intermediate layer 3 are formed in one body. Each of the conductive ceramic layer 4 and the intermediate layer 3 is the layer which contains silicon carbide (SiC), silicon (Si) and carbon (C).

When a paste of SiC—Si composite 41 is used in order to form the conductive ceramic layer 4, it is possible for the SiC—Si composite 41 to contain carbide (C) in advance.

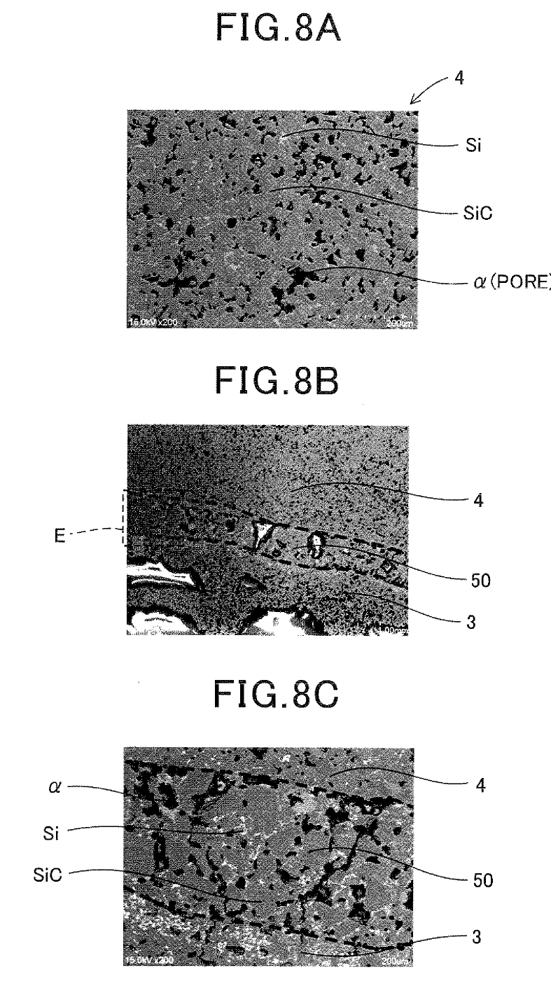

FIG. 8A is a view showing a cross section of the conductive ceramic layer 4 in the honeycomb structure body 1 according to the exemplary embodiment magnified 200 times by using an electron microscope. FIG. 8B is a view showing a cross section of a connection part between the conductive ceramic layer 4 and the intermediate layer 3 in the outer peripheral part 22 of the honeycomb structure body 1 according to the exemplary embodiment magnified 50 times by using an electron microscope. FIG. 8C is a view showing an enlarged cross section of the connection part indicated by reference character “E” (which is surrounded by dotted line) shown in FIG. 8B.

In FIG. 8A, FIG. 8B and FIG. 8C, reference character “a” indicates pores.

In FIG. 8A, silicon (Si) particles are shown in white, and arranged around the silicon carbide (SiC) particles so that the silicon (Si) particles bridge the silicon carbide (SiC) particles.

The conductive ceramic layer 4 has a low electric resistance value, when compared with that of the silicon carbide (SiC), and a superior electrical conductivity because the conductive ceramic layer 4 contains the silicon (Si) particles.

As shown in FIG. 8B and FIG. 8C, in the intermediate layer 3, the pores designated by reference character “a” formed in the outer peripheral part 22 are filled with the silicon (Si) particles, which are melted and dispersed into the intermediate layer 3 from the conductive ceramic layer 4.

The intermediate layer 3 connects the honeycomb base body 2 and the conductive ceramic layer 4 together. The intermediate layer 3 contains newly-produced silicon carbide (SiC), non-reacted silicon (Si) (shown in white) and carbon (C).

In FIG. 8B, reference number 50 indicates a part in which the adhesive 5 is formed before the thermal treatment. The part 50 in the adhesive 5 becomes a part of the conductive ceramic layer 4 after completion of the thermal treatment.

As omitted from FIG. 8A, FIG. 8B and FIG. 8C, the pores (or gaps) designated by reference character “a” formed between the silicon carbide (SiC) particles are formed in the base material layer 221 (shown in FIG. 1, FIG. 5 and FIG. 7). The base material layer 221 has an electrical resistance value which is approximately nine-times of the electrical resistance value of the conductive ceramic layer 4 and the intermediate layer 3. That is, the base material layer 221 has a low conductivity.

In the honeycomb structure body 1 according to the exemplary embodiment, the conductive ceramic layer 4 contains 70 to 94 mass % of silicon carbide (SiC), 5 mass % to 20 mass % of silicon (Si) and 1 mass % to 10 mass % of carbon (C). The conductive ceramic layer 4 has a uniform thickness within a range of 0.5 mm to 2 mm.

The outer peripheral part 22 of the honeycomb base body 2 in the honeycomb structure body 1 according to the exemplary embodiment has a uniform thickness within a range of 0.1 mm to 1 mm.

The intermediate layer 3 in the outer peripheral part 22 of the honeycomb base body 2 in the honeycomb structure body 1 according to the exemplary embodiment contains silicon carbide (SiC) within a range of 70 mass % to 94 mass %, silicon (Si) within a range of 5 mass % to 20 mass %© and carbon (C) within a range of 1 mass % to 10 mass %. The intermediate layer 3 has a uniform thickness within a range of 0.05 mm to 1 mm which is approximately 0.5 to 1 times of the thickness of the outer peripheral part 22 of the honeycomb base body 2.

The conductive ceramic layer 4 and the intermediate layer 3 in the honeycomb structure body 1 according to the exemplary embodiment made of silicon carbide (SiC) particles contain at least not less than 30% of one of 4H type and 3C type crystal system. In more detail, the conductive ceramic layer 4 contains 49.0% of 6H type crystal system, 22.3% of 4H type crystal system and 28.7% of 3C type crystal system of silicon carbide (SiC). The type of crystal systems can be calculated on the basis of X ray diffraction using an X ray diffraction device (RNT-2000 manufactured by Rigaku Corporation).

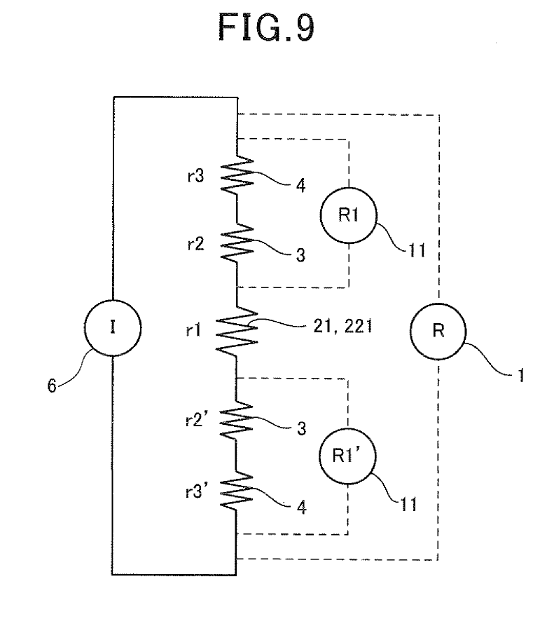

FIG. 9 is a view showing an electric circuit model when a voltage is applied to and current flows in the honeycomb structure body 1 according to the exemplary embodiment. As shown in FIG. 9, the electric power source 6 is electrically connected to the paired conductive ceramic layers 4, in other words to the paired electrodes 11. That is, FIG. 9 shows the electric circuit model which heats the honeycomb structure body 1 by Joule heating as electric heating.

As shown in FIG. 9, a resistance r1 of the honeycomb base body 2 as the base material is placed in the central part of the electric circuit model. (The resistance r1 is a resistance of the base material layer 221 in the cell formation part 21 and the outer peripheral part 22.) The resistances r2 and r2′ of the intermediate layer 3 are placed at the outside of the resistance r1 of the honeycomb base body 2. The resistances r3 and r3′ of the conductive ceramic layer 4 are placed at the outside of the resistances r2 and r2′ of the intermediate layer 3. In the electric circuit model shown in FIG. 9, the resistances r1, r2, r2′, r3 and r3′ are connected in series.

The resistance r2 of the intermediate layer 3 and the resistance r3 of the conductive ceramic layer 4 form the resistance R1 of one electrode 11 in the pair. This satisfies the relationship of R1=r2+r3.

The resistance R1′ of the other electrode 11 in the pair is made by the resistance r2′ of the intermediate layer 3 and the resistance r3′ of the conductive ceramic layer 4. This satisfies the relationship of R1′=r2′+r3′.

The paired electrodes 11 have the electrical resistance value R1+R1′ which is not more than 10% of the electrical resistance value R of a gap between the paired electrodes 11 (in the entire of the honeycomb structure body 1).

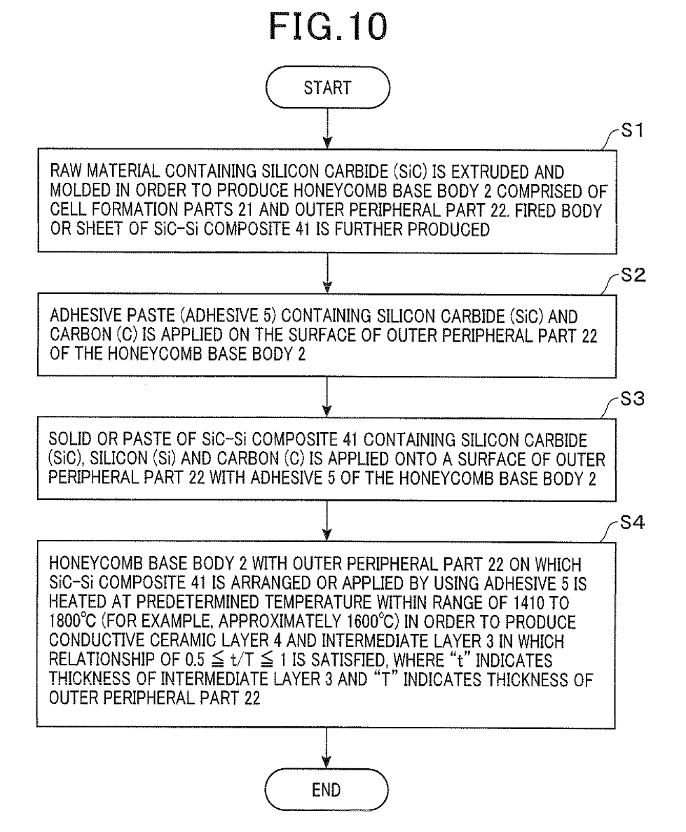

A description will now be given of the method of producing the honeycomb structure body 1 according to the exemplary embodiment with reference to FIG. 10.

FIG. 10 is a view showing a flow chart of producing the honeycomb structure body 1 according to the exemplary embodiment of the present invention.

At first, an extrusion and molding step extrudes and molds raw material containing silicon carbide (SiC) to produce the honeycomb base body 2 made of silicon carbide (SiC) (step S1).

The honeycomb base body 2 is comprised of a plurality of the cell formation parts 21 and the outer peripheral part 22. A plurality of the cells 212 is formed in the cell formation parts 21. The outer peripheral part 22 covers the outside surface of the cell formation parts 21.

A fired body or a sheet of the SiC—Si composite 41 is further produced. The SiC—Si composite 41 becomes the conductive ceramic layer 4.

Next, in a first process of arranging composite material or composite paste, an adhesive paste (as the adhesive 5) containing SiC and C is applied on the surface of the outer peripheral part 22 of the honeycomb base body 2 (step S2).

Following the applying step, a solid or paste of the SiC—Si composite 41 which contains silicon carbide (SiC), silicon (Si) and carbon (C) is placed or applied onto the surface of the outer peripheral part 22 with the adhesive 5 of the honeycomb base body 2 (step S3) (see FIG. 4).

Next, in a second process of heating and firing, the honeycomb base body 2 with the outer peripheral part 22 as intermediate, on which the SiC—Si composite 41 is arranged or applied by using the adhesive 5, is heated at a predetermined temperature (approximately 1600° C.) (step S4). The step S4 melts the silicon (Si) contained in the SiC—Si composite 41. The melted silicon (Si) and the carbon (C) in the adhesive 5 are dispersed and permeated in the outer peripheral part 22 and the SiC—Si composite 41. The temperature of heating and firing the honeycomb base body 2 with the outer peripheral part 22 as intermediate is higher than the melting point of silicon (Si). For example, it is preferred to heat and fire the intermediate at a temperature within a range of 1410° C. to 1800° C. The atmosphere in the above heating and firing step is executed in inert atmosphere such as argon atmosphere or vacuum.

During the step S4 of firing the intermediate layer 3, the intermediate layer 3 is formed in the outer peripheral part 22 of the honeycomb base body 2, and the conductive ceramic layer 4 is formed. This produces the honeycomb structure body 1 according to the exemplary embodiment. In particular, the conductive ceramic layer 4 and the intermediate layer 3 are produced and the following relationship is satisfied:

0.5≦t/T≦1, where “t” indicates the thickness of the intermediate layer 3 and “T” indicates the thickness of the outer peripheral part 22.

The conductive ceramic layer 4 and the intermediate layer 3 in the honeycomb structure body 1 according to the exemplary embodiment contain carbon (C) to be used for producing silicon carbide (SiC) and carbon (C) which is remained without chemical reaction. This structure decreases the electrical resistance of the conductive ceramic layer 4 and the intermediate layer 3 and increases the conductivity thereof.

There is a method of adjusting the quantity of non-reacted carbon (C) in the conductive ceramic layer 4 and the intermediate layer 3. The method adjusts the particle size of carbon particle contained in the adhesive 5.

When the particle size of carbon (C) is increased, silicon carbide (SiC) is generated on the surface of the carbon particle and non-reacted carbon (C) is remained in the inside of the carbon particle.

On the other hand, when the particle size of carbon (C) is decreased, silicon carbide (SiC) is generated approximately in the entire of the carbon particle.

Accordingly, it is possible to adjust the quantity of carbon (C), which is not reacted, remained in the conductive ceramic layer 4 and the intermediate layer 3. The carbon (C) contained in the adhesive 5 is made of carbon (C) having a particle size of less than 20 μm and carbon (C) having a particle size within a range of 20 μm to 50 μm. In particular, the carbon (C) having a particle size within a range of 20 μm to 50 μm has the total quantity of carbon (C) within a range of 3 mass % to 30 mass % contained in the adhesive 5.

It is preferred for the carbon (C) to have a particle size which is less than the size of pores formed in the outer peripheral part 22 of the honeycomb base body 2 in order to permeate the carbon particles to the inside of the pores formed in the outer peripheral part 22 of the honeycomb base body 2.

As described above, the honeycomb structure body 1 according to the exemplary embodiment satisfies the relationship of:

0.5≦t/T≦1, where “t” indicates the thickness of the intermediate layer 3 and “T” indicates the thickness of the outer peripheral part 22.

To have the thickness “t” of the intermediate layer 3 which is not less than the half of the thickness “T” of the outer peripheral part 22 makes it possible to prevent the resistance value of the paired electrodes 11 from being fluctuated by the repeated use of the honeycomb structure body 1, namely, the repeated supply of electric power to the paired electrodes 11 in the honeycomb structure body 1. In addition to this feature, it is possible to prevent the paired electrodes 11 from being damaged and separated from the surface of the outer peripheral part 22 of the honeycomb base body 2.

To have the thickness “t” of the intermediate layer 3 which is not more than the thickness “T” of the outer peripheral part 22 makes it possible to prevent the intermediate layer 3 from being formed in the inside of the cell formation part 21. This makes it possible to decrease the electrical resistance value of the cell formation part 21, and to prevent the function of rising the temperature of the honeycomb structure body 1 from being deteriorated.

According to the structure of the honeycomb structure body 1 of the exemplary embodiment, it is possible to obtain an optimum electrical connection reliability and optimum mechanical connection reliability even if the honeycomb structure body 1 is repeatedly used.

In addition, because the honeycomb structure body 1 according to the exemplary embodiment has the ratio Si/C in mass % between silicon (Si) contained in the SiC—Si composite 41 and carbon (C) contained in the adhesive 5 which is within a range of 0.6 to 3.3, it is possible to produce the intermediate layer 3 having the optimum thickness “t” having the important relationship of 0.5≦t/T≦1.

### (First Experiment of Qualification Test)

The qualification test was executed to detect the electrical resistance value (which corresponds to the electrical connection reliability) of the honeycomb structure body 1 and the presence of separation or damage (which corresponds to the mechanical connection reliability) of the honeycomb structure body 1 after completion of a temperature cycle test. In the qualification test, the thickness “t” of the intermediate layer 3 formed on the surface of the outer peripheral part 22 of each test sample as the honeycomb structure body was changed without changing the thickness “T” of the outer peripheral part 22. In each test sample used in the qualification test, the conductive ceramic layer 4 is made of approximately 83% of silicon carbide (SiC), approximately 15% of silicon (Si) and approximately 2% of carbon (C). In addition, the detection of the electrical connection reliability and the mechanical connection reliability described above was executed by the following steps.

Each test sample of the honeycomb structure body 1 was placed in an exhaust gas pipe of an internal combustion engine, and then heated for approximately 100 seconds until the central part of the honeycomb structure body 1 reached a temperature of 900° C. Next, after the heating step, the test sample as the honeycomb structure body 1 was kept without any treatment for approximately 200 seconds. Following this step, the test sample was cooled for approximately 300 seconds until the temperature of the central part of the honeycomb structure body 1 reached 200° C. The above temperature cycle test from a high temperature to a low temperature was repeated 500 times. After completion of the temperature cycle test, the qualification test of the honeycomb structure body 1 was executed.

The thickness of the outer peripheral part 22 and the thickness of the intermediate layer 3 were detected by the following steps.

Each test sample as the honeycomb structure body 1 was cut at the electrode formation part. The thickness of a cross section of the test sample was detected at ten points with a uniform interval by a scanning electron microscope (SEM). The detected ten thicknesses of each of the conductive ceramic layer 4 and the intermediate layer 3 were averaged in order to obtain an average value of the thickness.

The experiment 1 of the qualification test prepared 25 test samples X1 to X25 as the honeycomb base body 2 of the honeycomb structure body 1. Each of the test samples X1 to X25 as the honeycomb base body 2 was made of silicon carbide (SiC) of not less than 95%, a diameter of 93 mm, a thickness of 20 mm, a length of 20 mm, and a thickness of 0.3 mm of the outer peripheral part 22.

The test samples X1 to X25 were heated to a temperature of 1600° C. in argon gas atmosphere and the paired electrodes 11 composed of the conductive ceramic layer 4 and the intermediate layer 3 were formed on the honeycomb base body 2.

The paired electrodes 11 were formed on the surface of the honeycomb base body 2 so that an angle θ between the paired electrodes 11 along the circumference detected from the central point of a cross section of the honeycomb base body 2 is 78° (θ=)78° (see FIG. 1).

When the thickness of the outer peripheral part 22 is less than 0.1 mm, the strength of the honeycomb base body 2 is extremely decreased. Accordingly, the thickness of the honeycomb base body 2 in each of the test samples X1 to X25 is not less than 0.1 mm. On the other hand, when the thickness of the outer peripheral part 22 of the honeycomb base body 2 is more than 1 mm, the thermal capacity of the honeycomb base body 2 is increased and the temperature rising speed of the honeycomb base body 2 is decreased. In order to avoid this, each of the test samples X1 to X25 had the thickness of the outer peripheral part 22 within a range of 0.1 mm to 1 mm.

Each of the test samples X1 to X25 had the honeycomb base body 2 of a different porosity. The ratio “t/T” between the thickness “t” of the intermediate 3 and the thickness “T” of the outer peripheral part 22 in each of the test samples X1 to X25 was calculated and evaluated.

The test samples X1 to X25 had a different thickness of the intermediate layer 3 by adjusting the content of carbon (C) in the adhesive 5, the content of silicon (Si) on the conductive ceramic layer 4, and the period of time of executing the thermal treatment.

The porosity of the honeycomb base body 2 in the honeycomb structure body 1 as each of the test samples X1 to X25 was detected by a mercury porosimetry device (“auto pore” manufactured by SHIMADZU CORPORATION) having a detecting range of 0.5 to 10000 psia.

The evaluation of the electrical connection reliability of the test samples X1 to X25 was executed. The evaluation detected the change rate (or increasing rate) of the electrical resistance value of each of the test samples X1 to X25 at the timings before and after the temperature cycle test. Table 1 shows the evaluation results of the electrical connection reliability of the test samples X1 to X25 in which reference character “O” indicates the change rate of not more than 5%, “X” indicates the change rate of not less than 100%, and “Δ” indicates the change rate of a value which is between the change rates designated by “O” and “X”.

On the other hand, the evaluation of the mechanical connection reliability of the test samples X1 to X25 was executed by detecting the presence of the separation and damage of the conductive ceramic layer 4 before and after the temperature cycle test.

Table 1 shows the evaluation results of the mechanical connection reliability of the test samples X1 to X25 in which reference character “O” indicates no separation and damage in the conductive ceramic layer 4, “X” indicates that the conductive ceramic layer 4 is almost separated or broken, and “Δ” indicates that some part of the conductive ceramic layer 4 is separated or broken.

That is, Table 1 shows the evaluation results in electrical connection reliability and mechanical connection reliability of the test samples X1 to X25 when the porosity (%) of the honeycomb base body 2 and the ratio “t/T” between the thickness “t” of the intermediate layer 3 and the thickness “T” of the outer peripheral part 22 of the honeycomb base body 2 were changed.

TABLE 1

| | | | Evaluation | | |
|---|---|---|---|---|---|
| | | | results | | |
| | | Ratio of | Electrical | Mechanical | |
| | Porosity | thickness | connection | connection | Overall |
| Sample | (%) | t/T | reliability | reliability | results |
| X1 | 40.9 | 0.13 | X | X | X |
| X2 | 40.9 | 0.2 | X | X | X |
| X3 | 40.9 | 0.25 | X | Δ | Δ |
| X4 | 40.9 | 0.38 | Δ | Δ | Δ |
| X5 | 40.9 | 0.5 | O | O | O |
| X6 | 41.6 | 0.65 | O | O | O |
| X7 | 41.6 | 0.82 | O | O | O |
| X8 | 41.6 | 1.0 | O | O | O |
| X9 | 41.6 | 1.2 | O | O | X |
| X10 | 41.6 | 1.5 | O | O | X |
| X11 | 29.8 | 0.3 | Δ | Δ | Δ |
| X12 | 29.8 | 0.48 | O | O | Δ |
| X13 | 29.8 | 0.8 | O | O | Δ |
| X14 | 29.8 | 1.03 | O | O | Δ |
| X15 | 29.8 | 1.3 | O | O | X |
| X16 | 50.4 | 0.33 | X | X | X |
| X17 | 50.4 | 0.5 | O | O | Δ |
| X18 | 50.4 | 0.76 | O | O | Δ |
| X19 | 50.4 | 1.0 | O | O | Δ |
| X20 | 50.4 | 1.24 | O | O | X |
| X21 | 58.9 | 0.35 | X | X | X |
| X22 | 58.9 | 0.5 | X | X | X |
| X23 | 58.9 | 0.84 | Δ | Δ | Δ |
| X24 | 58.9 | 1.06 | O | O | Δ |
| X25 | 58.9 | 1.4 | O | O | X |

In Table 1, when the ratio “t/T” of the thickness is 0.13 (test sample X1) and 0.2 (test sample X2), both the electrical connection reliability and the mechanical connection reliability are designated by reference character “X”. Because the test samples X1 and X2 do not have sufficient connection thickness (or connection depth) between the conductive ceramic layer 4 and the outer peripheral part 22, the conductive ceramic layer 4 was separated, and it was difficult to detect the electrical resistance value of the test samples X1 and X2 as the honeycomb structure body 1.

When the ratio “t/T” of the thickness is 0.25 (test sample X3) and 0.38 (test sample X4), the electrical connection reliability of the test samples X3 is designated by reference character “Δ” and the mechanical connection reliability of the test sample X3 is designated by reference character “X”, the electrical connection reliability of the test sample X4 is designated by reference character “Δ” and the mechanical connection reliability of the test sample X4 is designated by reference character “Δ”.

Because a part of the conductive ceramic layer 4 is damaged during the temperature cycle test, the connection area is decreased and the resistance value of the test samples X3 and X4 as the honeycomb structure body 1 is thereby decreased.

When the ratio “t/T” of the thickness is 0.5 (test sample X5), 0.65 (test sample X6), 0.82 (test sample X7) and 1.0 (test sample X8), the electrical connection reliability and the mechanical connection reliability of all of the test samples X3 to X8 are designated by reference character “O”. Because no separation and damage occurs in the conductive ceramic layer 4 of the test samples X5 to X8 even if the temperature cycle test was executed. The test samples X5 to X8 as the honeycomb structure body 1 can maintain a low electrical resistance value thereof.

On the other hand, when the ratio “UT” of the thickness is 0.2 (test sample X9) and 1.5 (test sample X10), the electrical connection reliability and the mechanical connection reliability of all of the test samples X9 and X10 are designated by reference character “O”. However, in the test samples X9 and X10, because the intermediate layer 3 was formed in the inside of the cell formation part 21 of the honeycomb base body 2, the cell formation layer 21 of the honeycomb base body 2 had an electrical conductivity. This prevents the temperature of the cell formation layer 21 from being effectively increased even if electric power is repeatedly supplied, and the catalyst capability of the honeycomb structure body 1 was decreased. Therefore the test samples X9 and X10 are deteriorated (no-good) test sample in use.

Even if the porosity of the honeycomb base body 2 is 29.8% (test samples X11 to X15), 50.4% (test samples X16 to X20) and 58.9% (test sample X21 to X25), when the ratio “t/T” of the thickness takes a small value, the electrical connection reliability and the mechanical connection reliability of the test samples X16, X21 and X22 are designated by reference character “X”. In this case, these test samples X16, X21 and X22 had an insufficient connection thickness between the conductive ceramic layer 4 and the outer peripheral part 22 of the honeycomb base body 2.

When the porosity of the honeycomb base body 2 is 50.4% (test samples X16 to X20) and 58.9% (test sample X21 to X25), the strength of the honeycomb base body 2 of the test samples X16 to X20 and X21 to X25 was decreased. It is not suitable to use the test samples X16 to X25 even if the ratio “t/T” of the thickness thereof is within a range of 0.5 to 1.0.

On the other hand, when the porosity of the honeycomb base body 2 is 29.8% (test samples X11 to X15), it is necessary to use a large amount of electric power and time during the heating step using the electric power supply because the mass of the honeycomb base body 2 was increased. It is not suitable to use the test samples X11 to X15 even if the ratio “t/T” of the thickness thereof is within a range of 0.5 to 1.0.

As described above, the evaluation results of the test samples X5 to X8 clearly show that it is preferred that the ratio “t/T” between the thickness “t” of the intermediate layer 3 and the thickness “T” of the outer peripheral part 22 is within a range of 0.5 to 1 in order to keep the electrical connection reliability and the mechanical connection reliability. In addition, it is preferred for the honeycomb base body 2 to have the porosity within a range of 30% to 50%.

### (Second Experiment of Qualification Test)

The qualification test detected the electrical resistance value (which corresponds to the electrical connection reliability) of each test sample as the honeycomb structure body 1 and the presence of separation or damage (which corresponds to the mechanical connection reliability) of the test sample after completion of the temperature cycle test. Each test sample as the honeycomb structure body 1 has a different composition of the paired electrodes 11. As previously described in detail, the paired electrodes 11 are composed of the conductive ceramic layer 4 and the intermediate layer 3. That is, the composition of the paired electrodes 11 was changed in the qualification test.

The test samples are divided into two groups. One group has the structure of the conductive ceramic layer 4 and the intermediate layer 3 which has a two component layer composed of silicon carbide (SiC) and carbon (C). The other group has the structure of the conductive ceramic layer 4 and the intermediate layer 3 which has a three component layer composed of silicon carbide (SiC), silicon (Si) and carbon (C).

Table 2 shows the eleven test samples Y1 to Y11. One group includes the test samples Y1 to Y5 which have the paired electrodes 11 composed of the two composition layer. The other group includes the test samples Y6 to which have the paired electrodes 11 composed of the three composition layer. In Table 2, the numerals (such as “98” in “98SiC-2Si”) at the from part of the component (SiC, Si, or C) indicates the ratio of the component in the paired electrodes 11. The composition of the conductive ceramic layer 4 and the intermediate layer 3 was detected by using chemical analysis method indicated by JIS (Japanese Industrial Standard) R 6124.

TABLE 2

| | | | | Evaluation | |
|---|---|---|---|---|---|
| | | | | results | |
| | Composition of electrode | | Electrical | Mechanical | |
| | (A: 2 composition system) | | connection | connection | Overall |
| Sample | (B: 3 composition system) | | reliability | reliability | results |
| Y1 | A | 98SiC—2Si | X | X | X |
| Y2 | A | 95SiC—5Si | X | X | X |
| Y3 | A | 90SiC—10Si | Δ | O | Δ |
| Y4 | A | 80SiC—20Si | Δ | O | Δ |
| Y5 | A | 70SiC—30Si | Δ | Δ | Δ |
| Y6 | B | 94.5SiC—5Si—0.5C | Δ | O | Δ |
| Y7 | B | 94SiC—5Si—1C | O | O | O |
| Y8 | B | 90SiC—5Si—5C | O | O | O |
| Y9 | B | 85SiC—5Si—10C | O | O | O |
| Y10 | B | 80SiC—5Si—15C | O | Δ | Δ |
| Y11 | B | 70SiC—20Si—10C | O | O | O |

In the second experiment of qualification test, electrical terminals were connected to the paired electrodes 11 composed of the conductive ceramic layer 4 and the intermediate layer 3 in each of the test samples Y1 to Y11, While a current flowed in the paired electrodes 11 in each test sample through the electrical terminals, the voltage potential at a predetermined point was detected by using a digital volt meter. The second experiment was executed to detect the following three resistance values of the honeycomb base body 2 in each test sample:

(a-1) a resistance R1 of an electrode 11 containing a resistance r2 of the intermediate layer 3 and a resistance r3 of the conductive ceramic layer 4;

(a-2) a resistance R1′ of another electrode 11 containing a resistance r2′ of the intermediate layer 3 and a resistance r3′ of the conductive ceramic layer 4; and

(a-3) a resistance R1 of the honeycomb base body 2. The entire resistance of each test sample as the honeycomb structure body 1 was obtained by the following equation:

R=r1+R1+R1′.

The digital volt meter detected the voltage at the detection point (as designated by reference character “M” shown in FIG. 1) which is the partition wall 211 side in the outer peripheral part 22 of the honeycomb base body 2 to which the electrodes 11 were formed.

The resistance ratio of the paired electrodes 11 in the entire resistance of each test sample as the honeycomb structure body 1 was calculated by the following equation:

R1+R1′=(R1+R1′)/R*100%.

Table 2 shows the evaluation results of the electrical connection reliability of the test samples Y1 to Y11 as the honeycomb structure body 1 having the paired electrodes of two component (SiC—C) system or the three component (SiC—Si—C) system. In Table 2, reference character “O” indicates the test sample having the ratio of not more than 3% of the resistance (R1+R1′) of the paired electrodes 11 to the entire resistance (R) of the test sample as the honeycomb structure body 1. Reference character “X” indicates the test sample having the ratio of not less than 10% of the resistance (R1+R1′) of the paired electrodes 11 to the entire resistance (R) of the test sample as the honeycomb structure body 1. Reference character “A” indicates the test sample having the ratio within a range of less than 10% and more than 3% of the resistance (R1+R1′) of the paired electrodes 11 to the entire resistance (R) of the test sample as the honeycomb structure body 1.

Further, Table 2 shows the evaluation results of the mechanical connection reliability of the test samples Y1 to Y11 as the honeycomb structure body 1.

Table 2 shows the evaluation results of the mechanical connection reliability of the test samples Y1 to Y11 in which reference character “O” indicates no separation and damage in the conductive ceramic layer 4, reference character “X” indicates that the conductive ceramic layer 4 is almost separated or broken, and reference character “Δ” indicates that some part of the conductive ceramic layer 4 is separated or broken after completion of the temperature cycle test, like the first experiment of qualification test previously described.

Table 2 shows the results of the evaluation test of the electrical connection reliability and the mechanical connection reliability of each test sample.

It is preferred that the resistance of the paired electrodes 11 is not more than 10%.

When the resistance of the paired electrodes 11 is more than 10% and electric power is supplied to the paired electrodes 11 in order to increase the temperature of the honeycomb structure body to its activating temperature within a period of several ten seconds, the paired electrodes 11 generate a large heat energy and become overheated. This would be a possibility of causing damage to the paired electrodes 11 and an electric circuit to supply the electric power to the paired electrodes 11. It is therefore preferred for the paired electrodes 11 to have the resistance of not more than 3%.

In Table 2, when the paired electrodes 11 of the two component (SiC—C) system have 2 mass % of silicon (Si) (test sample Y1) and 5 mass % of silicon (Si) (test sample Y2), the electric connection reliability and the mechanical connection reliability are designated by the reference character “X”. It is impossible to detect the electrical resistance value of the test samples Y1 and Y2 because an adequate quantity of silicon (Si) was not supplied to the test samples Y1 and Y2, and the outer peripheral part 22 cannot be connected to the honeycomb base body 2.

When the paired electrodes 11 of the two component (SiC—C) system have 10 mass % of silicon (Si) (test sample Y3), 20 mass % of silicon (Si) (test sample Y4) and 30 mass % of silicon (Si) (test sample Y5), the electric connection reliability is designated by the reference character “A” (test samples Y3, Y4, and Y5), and the mechanical connection reliability is designated by reference character “O” (test samples Y3 and Y4) or the reference character “A” (test sample Y5). In the test samples Y3, Y4 and Y5, the conductive ceramic layer 4 is connected to the honeycomb base body 2, but it was difficult to adequately decrease the resistance value of the paired electrodes 11.

When the paired electrodes 1.1 have 30 mass % of silicon (Si), because there is a large quantity of silicon (Si) to be melted and dispersed into the outer peripheral part 22 of the honeycomb base body 2, the strength of the conductive ceramic layer 4 is decreased and the conductive ceramic layer 4 is damaged.

When the paired electrodes 11 of the three component (SiC—Si—C) system have 5 mass % of silicon (Si) and 0.5 mass % of carbon (C) (test sample Y6), the mechanical connection reliability is designated by the reference character “O”, but the electric connection reliability is designated by the reference character “Δ”. Because the paired electrodes 11 have a less quantity of carbon (C), it is impossible to adequately decrease the resistance of the paired electrodes 11.

When the paired electrodes 11 of the three component (SiC—Si—C) system have 5 mass % of silicon (Si) and 1 mass % of carbon (C) (test sample Y7), 5 mass % of silicon (Si) and 5 mass % of carbon (C) (test sample Y8), and 5 mass % of silicon (Si) and 10 mass % of carbon (C) (test sample Y9), the electric connection reliability and the mechanical connection reliability are designated by the reference character “O”. In the test samples Y7, Y8 and Y9, because non-reacted carbon (C) (which was not used when silicon carbide (SiC) is generated in the intermediate layer 3) remains in the conductive ceramic layer 4 and the intermediate layer 3, the conductive ceramic layer 4 and the intermediate layer 3 had good electrical conductivity by the presence of non-reacted carbon (C). It is thereby possible to keep the resistance of the paired electrodes 11 as low as possible. It is possible for the paired electrodes 11 to have a high strength by the presence of silicon (Si) of an optimum quantity.

When the paired electrodes 11 of the three component (SiC—Si—C) system have 5 mass % of silicon (Si) and 15 mass % of carbon (C) (test sample Y10), the electric connection reliability is designated by the reference character “O”, but the mechanical connection reliability is designated by reference character “Δ”. In the test sample Y10, because the conductive ceramic layer 4 and the intermediate layer 3 had carbon (C) rich, the conductive ceramic layer 4 and the intermediate layer 3 were brittle, and the conductive ceramic layer 4 and the intermediate layer 3 were damaged and cracks were generated therein.

Finally, when the paired electrodes 11 of the three component (SiC—Si—C) system have 20 mass % of silicon (Si) and 10 mass % of carbon (C) (test sample Y11), the electric connection reliability and the mechanical connection reliability are designated by the reference character “O”. Because the test sample Y11 has a small quantity of carbon (C), when compared with that of the test sample X15 of the two component (SiC—C) system containing 30 mass % of silicon (Si), it is possible to decrease the resistance of the paired electrodes 11 and increase and maintain the strength of the paired electrodes 11.

As described above, it is preferred for the conductive ceramic layer 4 and the intermediate layer 3 to have the composition of silicon carbide (SiC) within a range of 70 mass % to 94 mass %, silicon (Si) within a range of 5 mass % to 20 mass %, and carbon (C) within a range of 1 mass % to 10 mass %.

When the conductive ceramic layer 4 and the intermediate layer 3 have the content of silicon carbide (SiC) of less than 70 mass %, the content of silicon (Si) and carbon (C) is increased. This makes it difficult to maintain a necessary strength of the paired electrodes 11.

Further, when the conductive ceramic layer 4 and the intermediate layer 3 have the content of silicon carbide (SiC) of more than 94 mass %, the content of silicon (Si) and carbon (C) is low, namely, does not reach its necessary quantity. This makes it difficult to connect the conductive ceramic layer 4 and the intermediate layer 3 at the outer peripheral part 22 of the honeycomb base body 2.

When the conductive ceramic layer 4 and the intermediate layer 3 have the content of silicon (Si) of less than 5 mass %, it becomes difficult for silicon (Si) to adequately permeate into the outer peripheral part 22 of the honeycomb base body 2, and therefore difficult to connect the intermediate layer 3 and the conductive ceramic layer 4 together on the outer peripheral part 22 of the honeycomb base body 2.

On the other hand, when the conductive ceramic layer 4 and the intermediate layer 3 have the content of silicon (Si) of more than 20 mass %, a large quantity of silicon (Si) permeates into the outer peripheral part 22 of the honeycomb base body 2. This causes a possibility of decreasing the strength of the conductive ceramic layer 4.

When the conductive ceramic layer 4 and the intermediate layer 3 have the content of carbon (C) of less than 1 mass %, there is a possibility of it being difficult to adequately decrease the electrical resistance of the paired electrodes 11.

When the conductive ceramic layer 4 and the intermediate layer 3 have the content of carbon (C) of more than 10 mass %, there is a possibility of decreasing the strength of the paired electrodes 11.

### (Third Experiment of Qualification Test)

The third experiment of qualification test detected the degree of fluctuation of the thickness “t” of the intermediate layer 3 to the conductive ceramic layer 4 which are simultaneously formed when the conductive ceramic layer 4 is formed on the honeycomb base body 2 of test samples Z1 to Z6 having a different thickness “T” of the outer peripheral part 22. In particular, the test samples Z1 to Z6 have the intermediate layer 3 having the thickness “t” within a range of 0.5 T to 1 T. Further, in order to evaluate the fluctuation of the thickness “t” of the intermediate layer 3, the conductive ceramic layer 4 and the intermediate layer 3 of ten test samples, the outer peripheral part 22 thereof had the same thickness “T”, were formed by the same manufacturing condition

In the third experiment of qualification test, the thickness “t” of the intermediate layer 3 in each of the test samples Z1 to Z6 was detected and a standard deviation D of the detection results was calculated. In particular, each of the test samples Z1 to Z6 has ten test samples and the outer peripheral part 22 of each test sample has the same thickness “T”, as previously described.

The evaluation was executed by using the ratio “D/T” in order to detect the fluctuation of the thickness “t” of the intermediate layer 3 to the thickness “T” of the outer peripheral part 22.

A ratio “D/T” of more than a predetermined value indicates a large magnitude in fluctuation of the thickness “t” of the intermediate layer 3 to the outer periphery layer 22. In order to set a value within a range of 0.5 T to T to the thickness “t” of the intermediate layer 3, it is preferred for the intermediate layer 3 to decrease the fluctuation of the thickness “t”. In particular, it is preferred for the intermediate layer 3 to have the thickness “t” of not more than 0.2.

In Table 3, reference character “O” indicates the ratio “D/T” of not more than 0.2, reference character “X” indicates the ratio “D/T” of more than 0.2.

Table 3 shows the detection results of the ratio “D/T” which indicates the ratio in fluctuation of the thickness “t” of the intermediate layer 3 to the thickness “T” of the outer peripheral part 22 of the honeycomb base body 2 in each of test samples Z1 to Z6. The evaluation results indicate that the ratio “D/T” is more than 0.2 when the thickness “T” of the outer peripheral part 22 is more than 1.0 mm. This case has a possibility of it being difficult to form the intermediate layer 3 of a necessary thickness “t”. It is further difficult to form the outer peripheral part 22 having the thickness of less than 0.1 mm. It is therefore preferred for the outer peripheral part 22 to have the thickness “t” within a range of 0.1 mm to 1.0 mm.

TABLE 3

| | Thickness T (mm) of | Ratio D in | Ratio D/T of | Overall |
|---|---|---|---|---|
| Sample | outer peripheral part | fluctuation | fluctuation | results |
| Z1 | 0.2 | 0.03 | 0.15 | O |
| Z2 | 0.5 | 0.08 | 0.16 | O |
| Z3 | 0.8 | 0.13 | 0.16 | O |
| Z4 | 1.0 | 0.18 | 0.18 | O |
| Z5 | 1.2 | 0.27 | 0.23 | X |
| Z6 | 0.5 | 0.03 | 0.22 | X |

### (Fourth Experiment of Qualification Test)

The fourth experiment of qualification test detected the thickness “t” of the intermediate layer 3 of each of test samples W1 to W7 when the ratio “Si/C” between the content of silicon “Si” in the SiC—Si composite 41 and carbon “C” contained in the adhesive 5.

The fourth experiment of qualification test produced the test samples W1 to W7 as the honeycomb structure body 1 by the same method of the first experiment of qualification test, previously described. Each of the test samples W1 to W7 has the same porosity of 42%.

Each of the test samples W1 to W7 contains 83 mass % of silicon carbide (SiC), 15 mass % of silicon (Si), and 2 mass % of carbon (C). Each of the test samples W1 to W7 has the thickness T of 0.3 mm.

The fourth experiment of qualification test detected the thickness “t” of the intermediate layer 3 of each of test samples W1 to W7 when the ratio “Si/C” between the content of silicon “Si” in the SiC—Si composite 41 and carbon “C” contained in the adhesive 5 was changed.

In order to connect the honeycomb base body 2 with the conductive ceramic layer 4, the thermal treatment was executed at a temperature of 1600° C. in argon atmosphere for five hours.

In Table 4, reference character “O” indicates that the intermediate layer 3 was correctly formed and had the thickness “t” within a predetermined range of 0.15 mm to 3 mm, and reference character “X” indicates the intermediate layer 3 was not correctly formed and had the thickness “t” other than the predetermined range.

Table 4 shows the evaluation results of the relationship between the intermediate layer 3 and the thickness “t” in each test sample.

TABLE 4

| | | Thickness “t” of | |
|---|---|---|---|
| Sample | Si/C | intermediate layer | Overall results |
| W1 | 1.8 | 0 | X |
| W2 | 2.3 | 0 | X |
| W3 | 2.6 | 0.15 | O |
| W4 | 2.9 | 0.22 | O |
| W5 | 3.3 | 0.3 | O |
| W6 | 3.6 | 2 | X |
| W7 | 4.0 | 3.2 | X |

In Table 4, the test samples W1 and W2 have the ratio “Si/C” of 1.8 and 2.3, respectively, because no intermediate layer 3 was formed therein. The test samples W1 and W2 are therefore designated by reference character “X”. Because the test samples W1 and W2 had the adhesive 5 containing carbon (C) rich, the chemical reaction of generating silicon carbide (SiC) was occurred and completed in the inside of the outer peripheral part 22 of the honeycomb base body 2 and the adhesive 5. It was difficult to obtain the intermediate layer 3 with high connection reliability.

Further, the test samples W6 and W7 have the ratio “Si/C” of 3.6 and 4.0, respectively, because the intermediate layer 3 had the thickness “t” of the intermediate layer 3 of more than 0.3 mm. The test samples W6 and W7 are therefore designated by reference character “X”. During the formation of the conductive ceramic layer 4 and the intermediate layer 3 in the test samples W7 and W8, melting and permeation were repeatedly executed without converting excess silicon (Si) in the SiC—Si composite 41 to silicon carbide (SiC). This is not preferred because excess silicon (Si) is dispersed into the cell walls 211 formed in the cell formation part (lattice part) 21 through the outer peripheral part 22 of the honeycomb base body 2.

On the other hand, the test samples W3, W4 and W5 have the ratio “Si/C” of 2.6, 2.9 and 3.3, respectively. That is, the permeation of silicon (Si) and carbon (C) into the outer peripheral part 22 of the honeycomb base body 2 was correctly executed and the chemical reaction of generating silicon (Si) in the outer peripheral part 22 was correctly executed. This makes it possible to form the intermediate layer 3 having the desired thickness “t”.

According to the results of the fourth experiment of qualification test, it is preferred for the honeycomb structure body 1 to have the ratio “Si/C” within a range of 2.6 to 3.3.

It is possible to adjust the quantity of silicon (Si) in the SiC—Si composite 41 and carbon (C) in the adhesive 5 to the optimum quantity to the thickness “T” of the outer peripheral part 22 of the honeycomb base body 2 by adjusting the porosity of the honeycomb base body 2. It is preferred to adjust the quantity of silicon (Si) and carbon (C) so that the ratio “t/T” between the thickness “t” of the intermediate layer 3 and the thickness “T” of the outer peripheral part 22 of the honeycomb base body 2 satisfies the relationship of 0.5≦t/T≦1.

It is possible to form the intermediate layer 3 having the necessary thickness “t” when the conductive ceramic layer 4 is formed by adjusting the ratio “Si/C” without being affected by the period of time of executing thermal treatment (the heating time length).

It is preferred to execute the thermal treatment at a temperature within a range of 1410° C. to 1800° C. which can form silicon carbide (SiC) of a low temperature type. Still further, it is preferred to execute chemical reaction of generating silicon carbide (SiC) in the formation of the paired electrodes 11 over at least 30 minutes within the temperature range of 1410° C. to 1800° C.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A honeycomb structure body comprising:
a honeycomb base body composed of porous ceramics made of silicon carbide (SiC) having a porosity within a range of 30% to 50%, the honeycomb base body being comprised of a cell formation part and an outer peripheral part, an outer periphery of the cell formation part being covered with the outer peripheral part;
at least a pair of conductive ceramic layers made of silicon carbide (SiC) and silicon (Si) formed on the outer peripheral part; and
intermediate layers made of silicon carbide (SiC) and silicon (Si) formed in the outer peripheral part at the position which correspond to the conductive ceramic layers, wherein the honeycomb structure body satisfies a relationship of 0.5≦t/T≦1, where “t” indicates the thickness of the intermediate layer and “T” indicates the thickness of the outer peripheral part.

2. The honeycomb structure body according to claim 1, wherein the conductive ceramic layers and the intermediate layers further contain carbon (C).

3. The honeycomb structure body according to claim 2, wherein the conductive ceramic layers and the intermediate layers contain silicon carbide (SiC) within a range of 70 mass % to 94 mass %, silicon (Si) within a range of 5 to 20 mass %, and carbon (C) within a range of 1 mass % to 10 mass %.

4. The honeycomb structure body according to claim 1, wherein each of the conductive ceramic layers has a thickness within a range of 0.5 mm to 2 mm.

5. The honeycomb structure body according to claim 1, wherein the outer peripheral part has the thickness “T” within a range of 0.1 mm to 1 mm.

6. The honeycomb structure body according to claim 1, wherein the conductive ceramic layers and the intermediate layers connected together form a pair of electrodes, and an electric resistance of the paired electrodes is not more than 10% of the electric resistance of a gap between the paired electrodes.

7. The honeycomb structure body according to claim 1, wherein
the honeycomb structure body is produced by placing or applying composite material or composite paste containing silicon carbide (SiC) and carbon (C) onto an outer peripheral part of the honeycomb base body through adhesion paste containing silicon carbide (SiC) and carbon (C), and the adhesion paste and the composite material or composite paste is heated and fired,
wherein a ratio “Si/C” between silicon (Si) contained in the composite material or paste and carbon (C) contained in the adhesion paste is adjusted in order to permeate silicon (Si) contained in the composite material or paste and carbon (C) contained in the adhesion paste into the inside of the outer peripheral part and satisfy a relationship of 0.5≦t/T≦1, where “t” indicates the thickness of the intermediate layer and “T” indicates the thickness of the outer peripheral part.

8. The honeycomb structure body according to claim 7, wherein the ratio “Si/C” between silicon (Si) contained in the composite material or paste and carbon (C) contained in the adhesive is within a range of 2.6 to 3.3.
